(19) United States
(12) Patent Application Publication
(10) Pub. No.: US 2006/0236303 A1
(43) Pub. Date: Oct. 19, 2006

(54) Dynamically adjustable simulator, such as an electric circuit simulator

(76) Inventors: Thomas G. Wilson JR., Eden Prairie, MN (US); Ronald Chiu-Seung Wong, Framingham, MA (US)

Correspondence Address: PERKINS COIE LLP;PATENT-SEA, P.O. BOX 1247, SEATTLE, WA, 98111-1247, US

(21) Appl. No.: 11/392,258

(22) Filed: Mar. 29, 2006

Related U.S. Application Data
(60) Provisional application No. 60/667,533, filed on Mar. 29, 2005.
(60) Provisional application No. 60/678,994, filed on May 9, 2005.

(51) Int. Cl. G06F 9/44

(52) U.S. Cl. 717/104

(57) ABSTRACT

Technology that enables users to download to their local computing environment a simulation application and input data corresponding to a system having two or more interconnected components is described. The technology allows the user to perform a simulation in the user's local computing environment of the system of interconnected components described by the input data where the functionality of the simulation application is defined by instructions contained within the input data. In some examples, the invention enables a user to access a modified or relaxed set of features when simulating a system of interconnected components. The invention provides users with the ability to rapidly evaluate the performance of a manufacturer's product before purchase.

### CROSS-REFERENCE TO RELATED APPLICATION(S)

This application claims priority to U.S. Provisional Application No. 60/667,533, filed Mar. 29, 2005 and U.S. Provisional Application No. 60/678,994, filed May 9, 2005. This application is related to U.S. patent application Ser. No. 10/271,350, filed Oct. 15, 2002, which is a continuation of U.S. patent application Ser. No. 09/811,371, filed Mar. 14, 2001, now U.S. Pat. No. 6,530,065, issued Mar. 4, 2003, which claims the benefit of U.S. Provisional Patent Application No. 60/189,627, filed Mar. 14, 2000.

### BACKGROUND

A product designer, such as a designer of an electrical system or other component systems, typically must first consider which component parts to use within a product being designed. As the pressures mount to reduce the time required to design these new products, the need to be able to simulate product performance in the earliest stages of the design process is increasing. With the increasing need to simulate the performance of new designs, comes a corresponding increase in the need for simulation models of the components that make up the new design. There are many simulation application programs, such as SIMetrix/SIMPLIS, that provide a designer with a platform in which to simulate new designs. However, the simulation models of the critical components of these new designs required by many of these simulation applications are not compatible with one another. A simulation model for a component in one such simulation application is often not usable in another simulation application.

Manufacturers of critical components, such as Power Management IC Components, face the challenge of providing simulation models to customers. In practice, manufacturers cannot provide simulation models for each simulation application, nor can designers afford to purchase each simulation application.

As product designers and component manufacturers face shortening design cycle times that place both time and economic pressure on the designers, there is a need for a simulation system that allows manufacturers to provide simulation models of their components along with a compatible simulation application such that this combination is available and affordable to all potential customers.

### BRIEF DESCRIPTION OF THE DRAWINGS

FIG. 1 is an example of a flow diagram illustrating the flow of services between a manufacturer's design center and a user's local computing environment.

FIG. 2 is a block diagram illustrating an example of software architecture under some examples of the system.

FIGS. 3A-3B are examples of flow diagrams illustrating methods of providing simulation services to a user.

FIG. 4 is an example of a block diagram illustrating the contents of an input file.

FIG. 5 is an example of a web page depicting a manufacturer's design center providing a downloadable simulation package application and a list of downloadable input files provided to a user.

FIG. 6 is an example of a manufacturer's version of a simulation application displaying a system of interconnected components to be simulated.

FIG. 7 is an example of a manufacturer's splash display generated when invoking the manufacturer's version of the simulation application.

FIG. 8 is an example of a display depicting a wave form generated by the simulation of FIG. 6.

FIG. 9 is a block diagram of an example of a suitable computer for employing aspects of the invention.

FIG. 10 is a block diagram illustrating an example of a suitable system in which aspects of the technology may operate in a networked computer environment.

FIG. 11 is an example of an alternative system to that of FIG. 10.

FIG. 12 is a block diagram illustrating an example of software architecture under additional examples of the system.

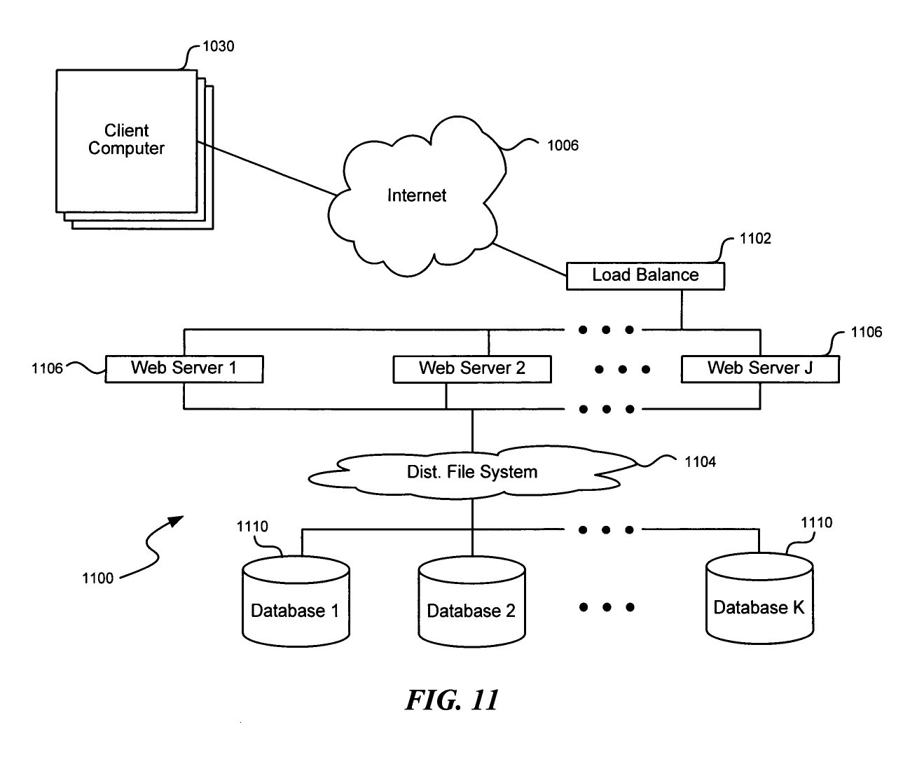

In the drawings, identical reference numbers identify identical or substantially similar elements or acts. To easily identify the discussion of any particular element or act, the most significant digit or digits in a reference number refer to the Figure number in which that element is first introduced (e.g., element 1104 is first introduced and discussed with respect to FIG. 11).

The headings provided herein are for convenience only and do not necessarily affect the scope or meaning of the claimed technology.

### DETAILED DESCRIPTION

Described in detail below are systems and corresponding methods for providing designs and simulations, such as for engineers designing products with electrical components. In some examples, a combination of an Internet based design service and a service by a simulation application provider allows manufacturers of semiconductor devices and/or other devices to provide downloadable simulation applications (such as a simulation application program) to end users. The system enables users to quickly simulate the performance of a manufacturer's product within the user's local computing design environment. After a one time download of a software application program from a manufacturer's design center, a user may simply select and download systems of interconnected components (such as circuit schematics) they would like to further analyze. Once a simulation application program and a system of interconnected components are in place in the user's local computing environment (such as their desktop computer), the user may execute all simulations in the user's local computing environment.

In order to protect manufacturers' products, a system handshake may be performed between the simulation application (or, simulation software program) and an input file that contains a description of a system of interconnected components. The system may assign a manufacturer a unique encryption key (such as an identification that corresponds to that manufacturer's software simulation applications) which accepts input files with some content encrypted with a corresponding key (such as inputs from the same manufacturer) and prohibits or severely limits users from using the manufacturer's applications to simulate input files taken from unauthorized sources (such as input files downloaded from a competitor). This gives these manufacturers a level of comfort that users of their simulation applications (such as engineers) may only be able to advantageously construct and simulate schematics that include that manufacturer's components. Therefore, in some aspects of the technology, the system provides a simulation application with a dynamically adjustable functionality determined by locked (or encrypted) content contained within an input file.

Moreover, in some cases it is advantageous to provide simulation applications tailored to the needs of a manufacturer and/or user. In these cases, the system enables manufacturers to provide users with simulation functionalities that may be specific to the manufacturer. For example, manufacturers may want to enable users to make modifications to a system of interconnected components (e.g., adding components to a schematic) and/or otherwise perform more detailed analysis of the schematic than might be practical or possible without a customized simulation application. In such cases, the system provides manufacturers with simulation applications that have features and capabilities that can be dynamically adjusted based on certain needs of the manufacturer or the user. The system may “lock” certain instructions within an input file. These instructions may adjust the functionality of a simulation application, allowing the simulation application to simulate a system of interconnected components that may be too large or too complex for a demonstration version of a simulation application. Therefore, when an application from a manufacturer is able to unlock the locked instructions of an input file (typically, when the application and input file are both provided by the same manufacturer), a user is able to take advantage of enhanced functionality of the application, depending on the content of the locked instructions within the input file.

The system enables a simulation application/service provider the ability to provide a variety of versions of the simulation application to manufacturers and their design center users, such as a manufacturer's version (modified version), a full value version (expanded version), and a demonstration version (available to users for free or very low cost). The manufacturer's version is typically provided to a user via a design center of a manufacturer (such as a website that provides the manufacturer's version of simulation applications and simulation models of the manufacturer's components). Specifically designed by the simulation application/service provider, the manufacturer's version may allow for a modified yet limited set of features, where advanced features (such as scripting, Monte Carlo and Worst Case analysis, and so on) that may be available in the full value version may or may not be available to a user of the manufacturer's version. However, the manufacturer's version may contain some features not available in the full value version (such as manufacturer specific branding and unique encryption capabilities). Additionally, the manufacturer's version may allow for a modified yet limited set of feature limitations (such as maximum circuit size, maximum simulation time, or maximum cpu time) which may be quantitatively adjusted by the simulation application/service provider to meet the needs of the manufacturer.

Users may wish to have more flexibility when running simulations (such as more feature choices and relaxed feature limitations), and may choose to purchase a full value version directly from the simulation application/service provider. Unlike the manufacturer's version, the full value version may be available for purchase and download directly from the simulation application/service provider. The full value version provides a user with a full set of features (such as scripting, Monte Carlo and Worstcase Analysis, and so on) and a relaxed set of feature limitations (such as unlimited or larger circuit sizes, simulation time, cpu time, and so on). In addition, the full value version may be compatible and enabled to simulate systems of interconnected components downloaded from a number of different manufacturers providing manufacturer's versions from their design centers.

As explained herein, aspects of the system permit manufacturers to provide numerous benefits to users; such as to provide dynamic information on products to interested users, gather information about customers' requirements, maintain control of the device evaluation experience, create positive customer (and user) experience at manufacturers' web sites, support smaller customer accounts with cost savings and virtual tools, and quickly generate worldwide impact via the Internet.

As also described herein, aspects of the technology permit end users to reduce time spent in evaluating products or devices, quickly obtain technical information specific to their hypothetical questions or analyses, reduce time to market of a product under design, avoid wasting time because the simulation models provided by the manufacturer are not compatible with the particular simulation application to which the user may have access, and other benefits.

Various examples of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Representative System

As discussed above, in some cases the system presents simulation applications and component models (to be analyzed in downloadable form) to end users so that simulations of those schematics may be carried out by the end users in their local computing environment. For a more detailed description of the simulation process, see co-pending and commonly assigned U.S. patent application Ser. No. 09/811,371, filed Mar. 14, 2001, now U.S. Pat. No. 6,530.065. issued Mar. 4, 2003.

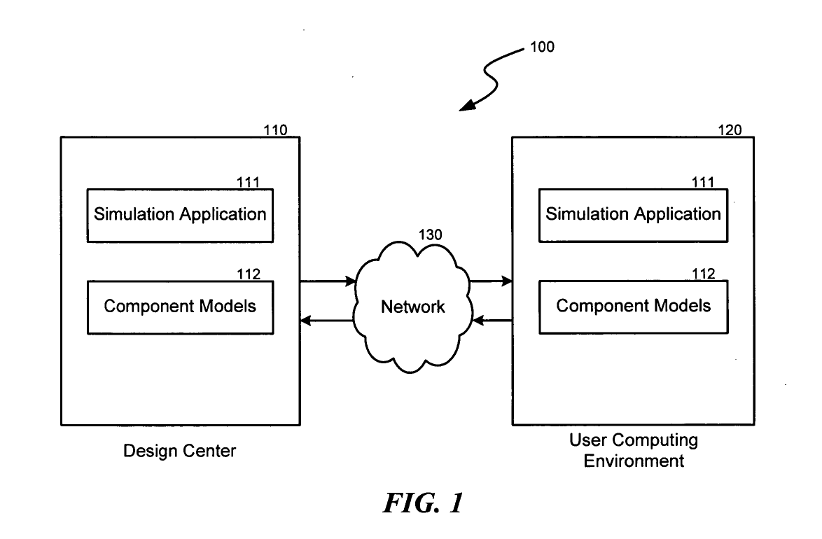

Referring to FIG. 1, a flow diagram illustrating the flow of services between a manufacturer's design center and a user's local computing environment (such as the user's desktop) under some embodiments of the technology is shown.

A user's local computing environment, e.g., desktop computer 120, connects to a manufacturer's design center 110 via network 130 such as the internet or the manufacturer's private intranet. As mentioned above, the design center may be a webpage or other means of distributing simulation applications and component models to end users. The design center provides a downloadable simulation application 111, such as a SIMetrix/SIMPLIS package, which is described in more detail herein. The simulation application may include one or more simulation engines, features to capture input files in a textual or graphical manner, features to control, analyze results of the simulation, and so on. Further aspects of the simulation are discussed in greater detail below.

The design center also provides an input file 112 to be run in the simulation application 111. The input file (or “input”) contains, among other things, a system of interconnected components, such as a circuit schematic. The input is a machine readable description of the system to be simulated. In many cases, the input is a file; however, the input may be any stream of data capable of describing a system of interconnected components to the simulation application. Additionally, an input file may have one or more of the following features: information required to present a visual description of the system to be simulated, instructions indicating what type of simulation analysis is to be performed, instructions indicating how simulation results are to be displayed, modifying instructions that can be interpreted by certain simulation applications resulting in enabling certain modified functionalities of a simulation application, modifying instructions that can be interpreted by certain simulation applications resulting in the simulation application dynamically adjusting the functionality, and so on.

A user may then download the simulation application 111 and the input file 112 to a user's local computing environment 120. The user is then able to run simulations in their local computing environment with the downloaded simulation application 111 and downloaded input file 112.

The design center may provide simulation applications and/or input files to users in a variety of ways, such as via direct download, via email or other electronic dissemination, via physical media such as CDs or other memory devices.

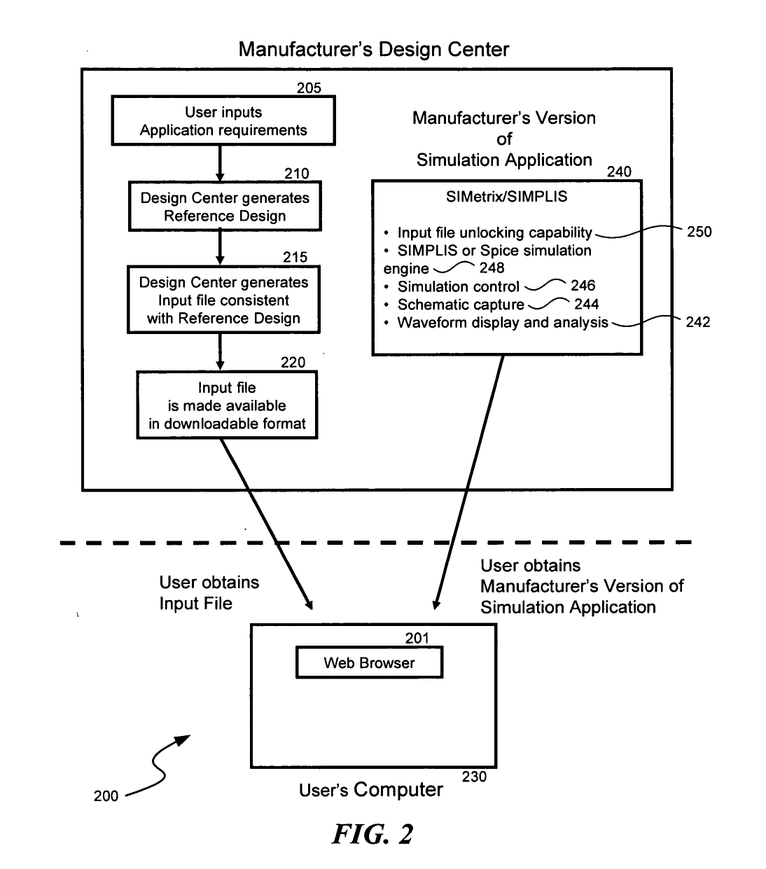

Referring to FIG. 2, a block diagram illustrating an example of software architecture 200 of a manufacturer's Design Center under some embodiments of the invention is shown. The system enables a user to input their design requirements at component 205. The system then uses the user's design requirements to generate a reference design via reference design generation block 210. Typically, the resulting reference design will include at least one of the manufacturer's components. As described in co-pending and commonly assigned U.S. patent application Ser. No. 10/271,350, filed Oct. 15, 2002, descriptions for various devices (such as circuit components, and so on) are stored as netlists. The stored netlists exchange data with a test generation block that generates simulation tests to be performed on a component model. The generated tests of test generation block proceed to an input generation block 215 to generate an input 220. In the input generation block, generated tests, display instructions, simulation control instructions and waveform processing instructions are created along with the netlist data, and a complete input file 220 is presented in downloadable form. The created input file contains a description of a system of interconnected components (such as a circuit schematic) and all the information needed to run simulations and perform additional simulation analysis. The created input file is then available for download by a user via web browser 201. After download, the user may then run the input file 220 in the downloaded simulation application 240 on their computer 230.

In some cases, the downloaded simulation application is preferably the SIMetrix/SIMPLIS package introduced earlier. Similar to the SIMPLIS package described in co-pending and commonly assigned U.S. patent application Ser. No. 10/271,350, filed Oct. 15, 2002, the SIMetrix/SIMPLIS package contains additional features which facilitate running simulations within the desktop computer environment. These features include a waveform display and processing element 242, a schematic capture element 244, a simulation control element 246, the SIMPLIS (or SPICE) element 248, and an input unlocking element (such as an element readily configured to decrypt certain encrypted content) 250. One skilled in the art will realize that the system may employ other simulation packages in order to run and analyze downloaded input files containing descriptions of interconnected components. Examples of some of these simulation packages include PSpice, Saber and Simplorer for electrical simulations, Ansys, Nasys and Nastran for mechanical simulations, Maxwell, Flux2D, and Flux3D for electro-magnetic simulations, SIMPLORER, SystemVision and Saber for electro-mechanical simulations, FloTherm, Fluent and CD-Adapco for computational fluid dynamic simulations, FloTherm and TASPCB for thermal simulations, and so on.

Therefore, by simply downloading an input file 220 and a simulation application 240 (such as the manufacturer's version), a user is able to launch and run simulations on the user's local computer of a reference design that includes component models provided by a manufacturer.

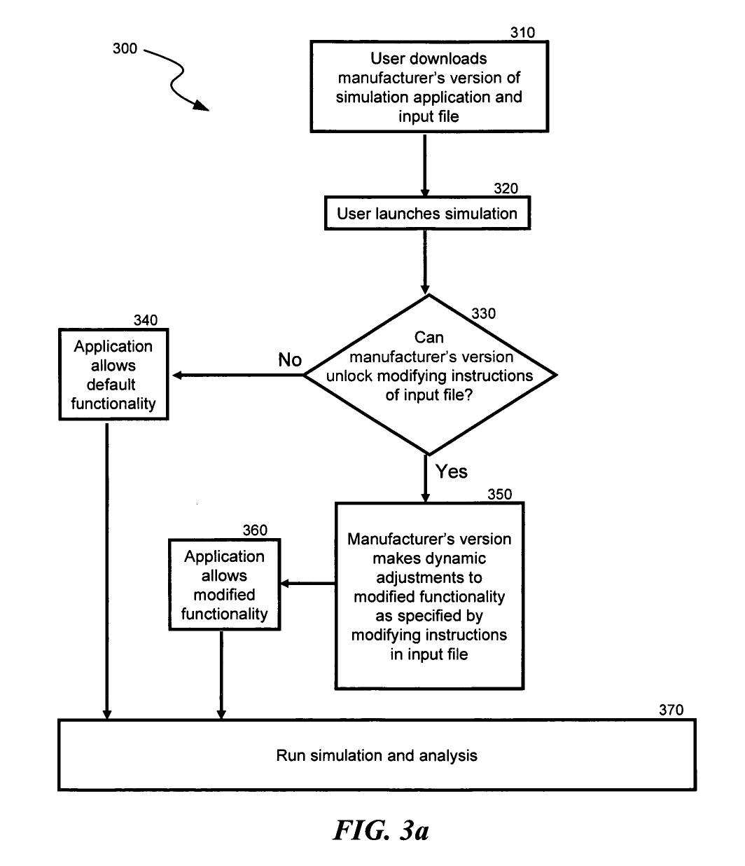

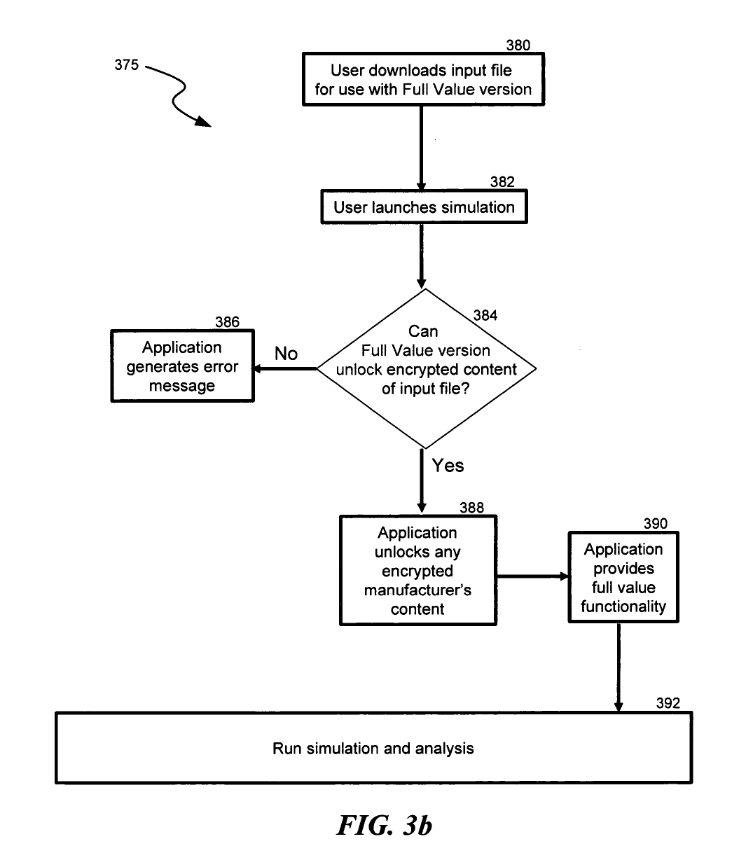

Referring to FIG. 3A, an example of a flow diagram 300 illustrating a method of providing simulation services to a user from a manufacturer using a manufacturer's version of the simulation application is shown. This flow diagram (and other diagrams discussed herein) does not show all functions or exchanges of data but, instead, provides an understanding of commands and data exchanged under the system. Those skilled in the relevant art will recognize that some functions or exchanges of commands and data may be repeated, varied, omitted, or supplemented, and other aspects not shown may be readily implemented. In block 310, the system provides a user a choice of simulation applications (such as the SIMetrix/SPICE package) to be downloaded from a manufacturer's design center. The system also provides the user one or more input files (each containing a system of interconnected components) to be downloaded from the manufacturer's design center. Upon the user choosing a simulation application (such as one or more differing versions for that manufacturer) and input file, the system transfers the chosen simulation application and chosen input file to the user (e.g., the user downloads the simulation application and input file to their local computing environment).

In block 320, the system receives instructions from the user to launch a simulation of the system of interconnected components (described in the input file) using the manufacturer's version of the simulation application. In decision block 330, the system attempts to unlock modifying instructions contained within the input file.

If the simulation application is not able to unlock the modifying instructions in the input file requesting additional functionality from the simulation application, the system merely provides a default functionality 340. This default functionality may be severely restricted compared with the functionality typically found in certain manufacturer's versions (or other versions, such as the full value version described below), and may be similar to the functionality provided by a demonstration version of the application.

If the application is able to unlock the modifying instructions in the input file requesting additional functionality, the system makes dynamic adjustments 350 to the functionality of the simulation application as specified by the unlocked instructions (e.g., instructions modifying the application, relaxed feature limitations, allowing a larger number of components to be simulated, and so on), and provides a modified functionality 360 (which may be a manufacturer-specific functionality). In block 370, the application runs a simulation and analysis of the schematic, utilizing the functionality provided in either block 340 or block 360. The simulation may be executed in the user's local computing environment.

In a possible alternative to decision block 330, the simulation application may incorporate the use of two encryption keys to unlock the encrypted identification related to validation and functionality of a modified version. For example, the process may involve the system having two encryption keys within a simulation application to allow the system (via the simulation application) to separately verify an input file using one encryption key (used to unlock instructions relating to the identification of the input file as being from a certain manufacturer) and provide access to enhanced functionality of the application using another encryption key (used to unlock other instructions related to the functionality associated with the simulation application).

Referring to FIG. 3B, an example of a flow diagram 375 illustrating a method of a manufacturer providing simulation services to a user using a full value version of the simulation application is shown. This process may be similar to the process flow described with respect to FIG. 3A. In block 380, the system provides the full value version of the simulation application to the user to be downloaded directly from the simulation application/service provider. The system also provides the user one or more input files (each containing a system of interconnected components) to be downloaded from one or more manufacturer design centers. Upon the user choosing (and likely purchasing from the simulation application/service provider) the full value version of the simulation application and obtaining an input file from a manufacturer's design center, the system transfers the simulation application and chosen input file to the user (e.g., the user downloads the simulation application and input file to their local computing environment).

In block 382, the system receives instructions from the user to launch a simulation of the system of interconnected components (provided from the input file) within the full value version of the simulation application. In decision block 384, the system (via the full value version) attempts to unlock any encrypted content contained within the input file. If the system cannot unlock the encrypted content, the system may return an error message 386 or otherwise not function. Alternatively, the system could provide the default functionality described above. The simulation may be executed in the user's local computing environment.

If the application is able to unlock the encrypted content, the system is able to utilize any and all content encrypted (i.e, “locked”) within the input file and provides a full value functionality 390. The full value functionality, as mentioned above, enables the system to provide a user with a powerful simulation application that may place little or no restrictions on the availability of features or limits on feature capability. In block 392, the application runs a simulation and analysis of the system of interconnected components described by the input file, utilizing this full value functionality.

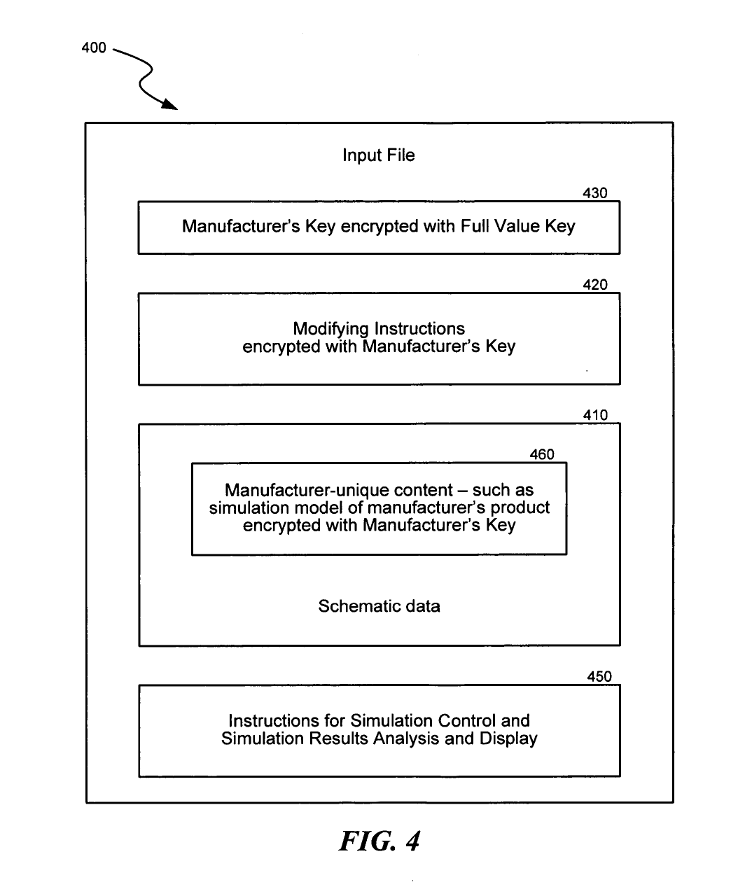

Referring to FIG. 4, a block diagram illustrating the components of an example input file 400 is shown. The input file 400 comprises data related to a system of interconnected components, such as a schematic 410 (which may include encrypted manufacturer-unique content, such as at least a portion of a simulation model of one of the manufacturer's component products 460) and modifying instructions 420 encrypted with a manufacturer's key, that enable the modified functionality for the manufacturer's version of the simulation application. This modified functionality may include instructions on which features to enable, instructions on which default feature restrictions to relax, quantitative instructions of how much to relax the restrictions, and so on. Additionally, the input file may comprise the manufacturer's key 430 encrypted with a full value key (wherein the full value key may only be unlocked by the full value version of the simulation application), and instructions for the control, display and analysis of simulation results.

One skilled in the art will realize that the structure of the input file is not limited to a particular data file, and may be any data stream, text, schematic or binary file capable of describing the interconnect of components (such as the modeling of circuit components), as long as the file is able to define a simulation within a simulation application.

Certain desired portions 420, 430, and optionally 460, of the complete input may be encrypted with the manufacturer-unique key during the input file creation process before the input file is downloaded by a user, so certain information specific to a manufacturer is never accessible to a user. Other portions, such as portions of the schematic data, may or may not be encrypted. The simulation application/services provider may assign each manufacturer a unique encryption key. Each encrypted input file may then comprise two stages of encryption, a first stage (manufacturer-unique) that encrypts the modifying instructions 420 that describe the modified functionality of a manufacturer's version of the simulation application, and, possibly, 460 and a second stage 430 (full value) that encrypts the manufacturer's key to be accessed by the full value version of the simulation application so that the full value version may be able to decrypt the manufacturer specific content. The encryption keys are preferably a string of bytes, but may also be a table or other types of data blocks typically used in encryption techniques. Additionally, content of certain desired portions may also be scrambled or otherwise secured with techniques other than encryption techniques.

The staged encryption, among other things, enables users to use the full value version of the simulation application with manufacturers' input files created after the user obtained the full value simulation application, as the input file itself contains it's own encryption key (the manufacturer's key). Therefore, the full value version does not have a number of different keys; instead, it contains one key (the full value key) that, upon receiving an input file to be simulated, unlocks the manufacturer's key contained within the input file. The manufacturer's key can then be used to unlock all the manufacturer-unique content for use with the full value version.

Alternatively, certain portions may be encrypted separately, that is, certain content within the input file may be separately encrypted. For example, modifying instructions 420 may be encrypted with one key and manufacturer-unique content 460 may be encrypted with another. Other encryption or security methods may of course be employed.

The system, in addition to the handshake encryption discussed above, may implement additional measures of security in order to protect the information contained in certain desired portions of the input file. For example, even after a simulation application decrypts desired portions of the input file and runs a simulation, a user cannot access the decrypted information, because the information is only available within the program while the simulation is running. No decrypted content is made available to the user, as the application simply accesses the information necessary to perform a simulation. Therefore, a user only would have access to certain desired information in its encrypted form.

As a possible extension to that described above, a manufacturer's version of the application may be configured to proceed directly and only to the validation of the input file. For example, severely restricted manufacturer's versions may contain only an encryption key able to unlock encryption keys related to the validation of the input file. However, in other examples, the manufacturer's version of the simulation application contains additional encryption keys and may separately decrypt different components of the input file (such as separately decrypting modifying instructions 420 with one key and manufacturer-unique content 460 with another. Also, in some examples, the simulation application may decrypt the validation encryption key containing a manufacturer-unique content (such as an authorization identification) and then have access to a encryption key that is then used to unlock additional encryption keys to provide modified functionality.

An additional feature of the system is that the manufacturer's version of the simulation application may be enabled to run simulations driven by input files from more than one approved source. In other words, the manufacturer's version may be enabled to decrypt input files from other pre-approved manufacturers. This is accomplished by allowing the manufacturer's version to have more than one manufacturer-unique encryption key, so that it may be able to decrypt more than one input file containing manufacturer-unique content. Additionally, input files may include encrypted content from more than one manufacturer. In these cases, in addition to being able to unlock its own manufacturer-unique content in the input file, the manufacturer's version may comprise additional keys that enable the simulation application to unlock content from other approved manufacturers.

Those skilled in the art will appreciate that the system may be used to simulate component models in many fields of technology. Although some of the examples herein describe the system for use in simulating electrical circuit schematics, the system also may be used in simulating electromagnetic, electromechanical, magnetic, thermal, fluid dynamics, business process, and systems of other types of interconnected components.

Suitable Screen Displays of the System

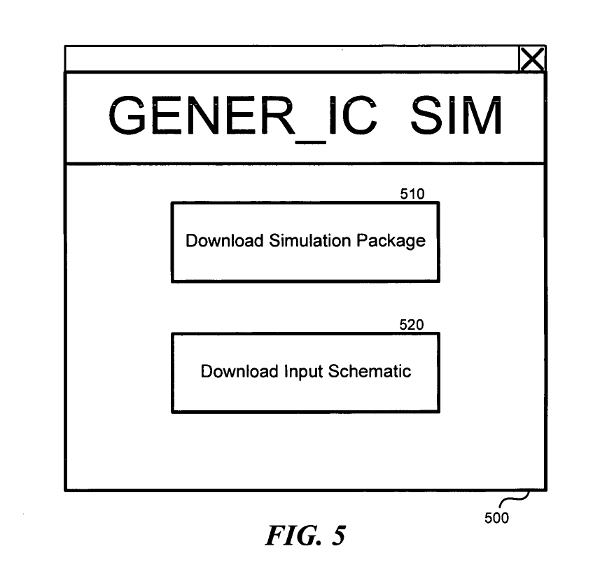

Referring to FIGS. 5 through 8, representative computer displays will now be described in accordance with some embodiments. These displays are provided with respect to the manufacturer's version of the simulation application. However, using the full value version leads to similarly displayed content.

Referring to FIG. 5, an example of a web page 500 depicting a manufacturer's design center providing a downloadable simulation application and a list of downloadable schematics provided to a user is shown. The web page 500 provides options to download a desired simulation package 510 to a user's local computing environment. The web page 500 also provides options to download a desired schematic 520, according to the needs of the user. Once the user has completed the downloads, the user is able use their local computing environment to run simulations of the schematic 520.

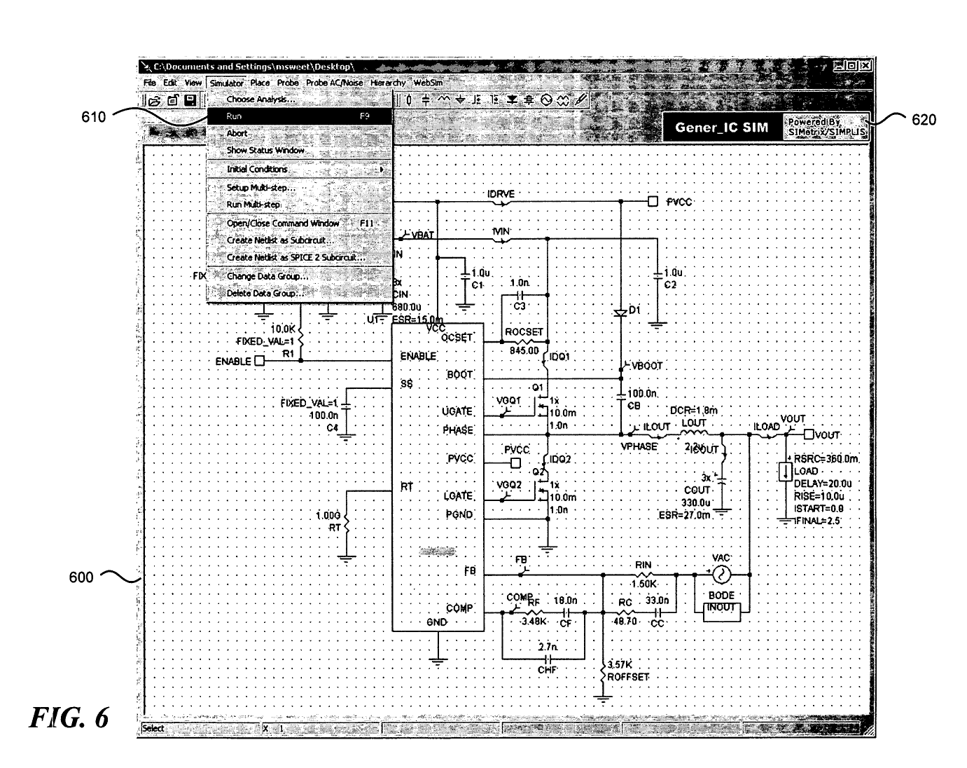

Referring to FIG. 6, an example of a display 600 depicting a reference application circuit is shown. The system may receive a selection 610 from a user to “run” a simulation from the “simulation” drop down menu and initiates a simulation of a schematic downloaded from design center 500. Because the manufacturer's version of the simulation package includes a schematic capture feature, the system enables the user to make significant modifications to the topology of the downloaded circuit. The display may be specifically designed for the manufacturer, including a portion 620 showing the manufacturer's name, in this example “Gener_IC”, and the manufacturer's private labeled name of the manufacturer's version of the simulation package, in this example “Gener_IC SIM.”

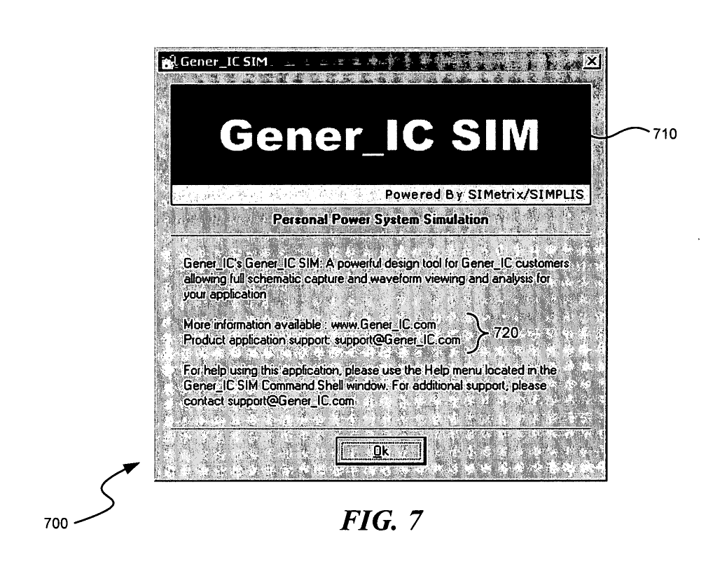

Referring to FIG. 7, an example of a manufacturer's splash page display 700 generated each time the user evokes the manufacturer's version of the simulation application is shown. One of the modified features available to manufacturers includes showing information about the manufacturer while the simulation package runs a simulation. The manufacturer may choose to show their name 710 and web address 720, or other such branding or marketing messages or advertisements.

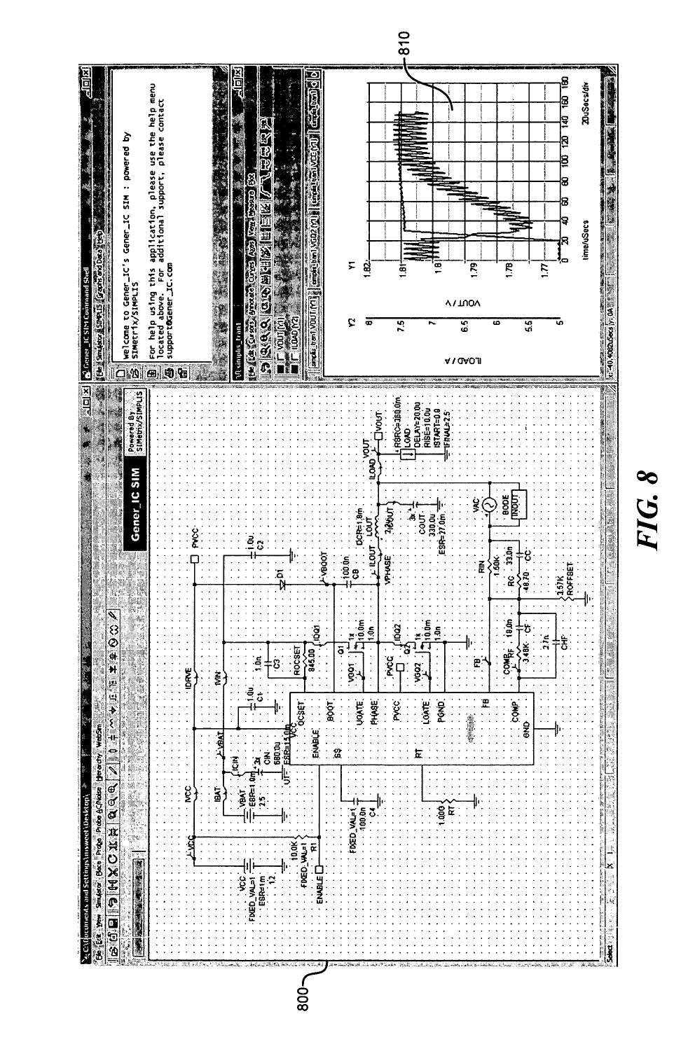

Referring to FIG. 8, an example of a display 800 depicting a wave form generated by the simulation of FIG. 6 is shown. A waveform 810 is generated by the simulation of a schematic. The waveform generation technique is similar to the technique discussed in commonly assigned U.S. patent application Ser. No. 10/271,350. filed Oct. 15, 2002.

Suitable Computing System

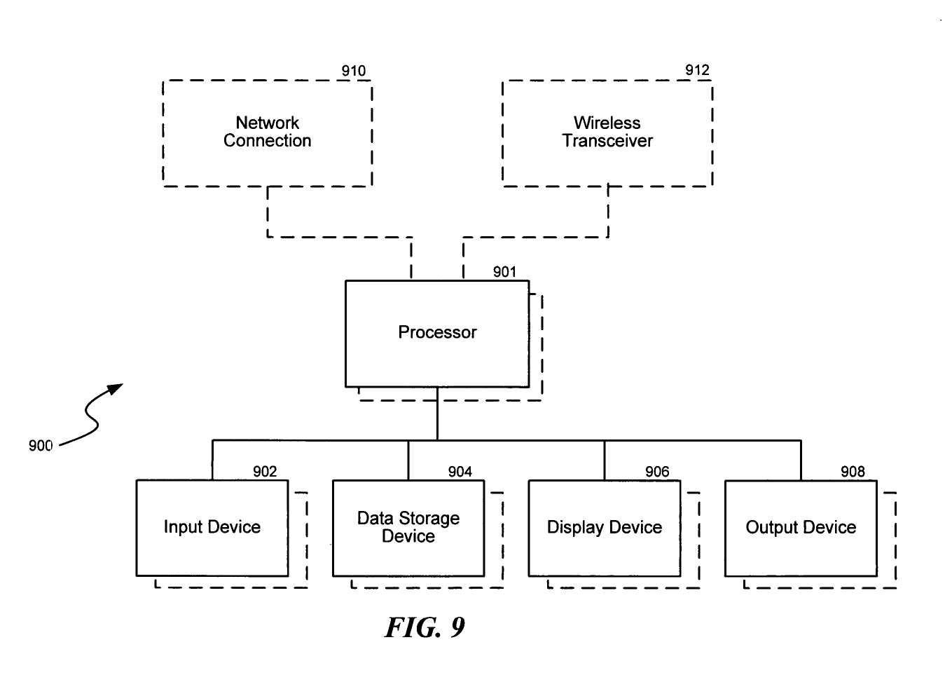

FIG. 9 and the following discussion provide a brief, general description of a suitable computing environment in which aspects of the invention can be implemented. Although not required, aspects and embodiments of the invention will be described in the general context of computer-executable instructions, such as routines executed by a general purpose computer (e.g., a server or personal computer). Those skilled in the relevant art will appreciate that aspects of the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. Aspects of the invention can be embodied in a special purpose computer or data processor that is specifically programmed, configured or constructed to perform one or more of the computer-executable instructions explained in detail below. Indeed, the term “computer,” as used generally herein, refers to any of the above devices as well as to any data processor.

Aspects of the invention can also be practiced in distributed computing environments where tasks or modules are performed by remote processing devices and which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs stored as firmware in chips (e.g., EEPROM chips), as well as distributed electronically over the Internet or other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 9, some embodiments of the invention employ a computer 900, such as a personal computer or workstation, having one or more processors 901 coupled to one or more user input devices 902 and data storage devices 904. The computer is also coupled to at least one output device such as a display device 906 and one or more optional additional output devices 908 (e.g., printer, plotter, speakers, tactile or olfactory output devices, etc.). The computer may be coupled to external computers, such as via an optional network connection 910, a wireless transceiver 912 or both.

The input devices 902 may include a keyboard and/or a pointing device such as a mouse. Other input devices such as a microphone, joystick, pen, game pad, scanner, digital camera, video camera and the like are possible. The data storage devices 904 may include any type of computer-readable media that can store data accessible by the computer 900, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 9).

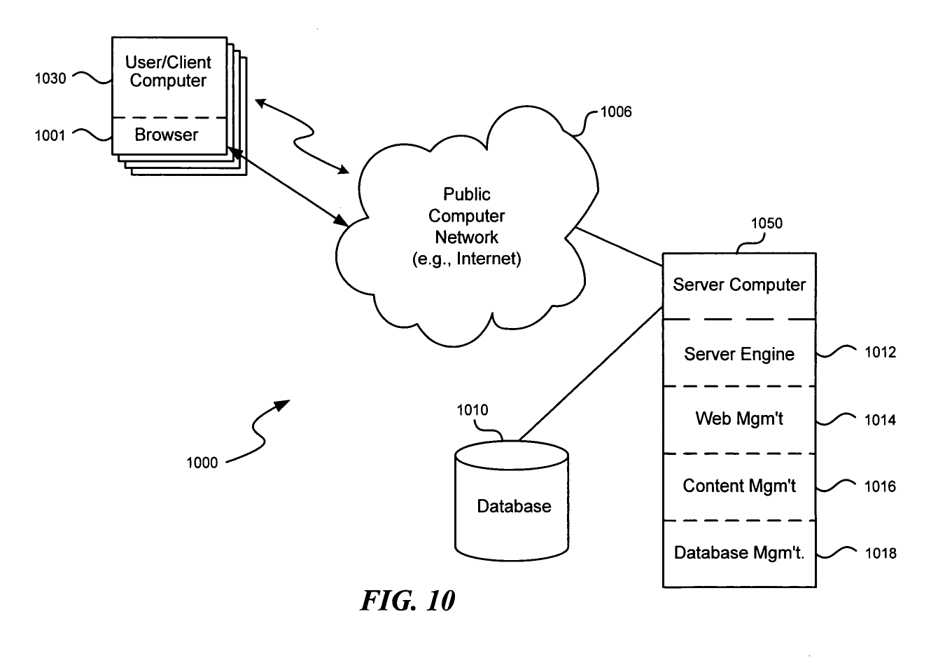

Aspects of the invention may be practiced in a variety of other computing environments. For example, referring to FIG. 10, a distributed computing environment with a web interface includes one or more user or client computers 1030 in a system 1000 are shown, each of which includes a browser program module 1001 that permits the computer to access and exchange data with the Internet 1006, including web sites within the World Wide Web portion of the Internet. The user computers may include one or more central processing units or other logic-processing circuitry, memory, input devices (e.g., keyboards and pointing devices), output devices (e.g., display devices and printers), and storage devices (e.g., magnetic, fixed and floppy disk drives, and optical disk drives), such as described above with respect to FIG. 8. User computers may include other program modules such as an operating system, one or more application programs (e.g., word processing or spread sheet applications), and the like. The user computers 1030 include wireless computers, such as mobile phones, personal digital assistants (PDA's), palm-top computers, etc., which communicate with the Internet via a wireless link.

At least one server computer 1050, coupled to the Internet or World Wide Web (“Web”) 1006, performs much or all of the design center functions for receiving, routing and storing of electronic messages, such as web pages, and the hosting of the downloads of the simulation application and the input data. While the Internet is shown, a private network, such as an intranet may likewise be used herein. A database 1010, coupled to the server computer, stores much of the web pages and content exchanged with or to the user computers. The server computer, including the database, may employ security measures to inhibit malicious attacks on the system, and to preserve integrity of the messages and data stored therein (e.g., firewall systems, secure socket layers (SSL) password protection schemes, encryption, and the like).

The server computer includes a server engine 1012, a web page management component 1014, a content management component 1016 and a database management component 1018. The server engine performs basic processing and operating system level tasks. The web page management component handles creation and display or routing of web pages. Users may access the server computer by means of a URL associated therewith (e.g., http://www.transim.com). The content management component handles most of the functions in the embodiments described herein. The database management component includes storage and retrieval tasks with respect to the database, queries to the database, and storage of data such as the waveform data, netlists and other files.

Referring to FIG. 11, an alternative embodiment to the system 1000 is shown as a system 1100. The system 1100 is substantially similar to the system 1000, but includes more than one web server computer (shown as server computers 1, 2, . . . J). A web load balancing system 1102 balances load on the several web server computers. Load balancing is a technique well-known in the art for distributing the processing load between two or more computers to thereby more efficiently process instructions and route data. Such a load balancer can distribute message traffic, particularly during peak traffic times.

A distributed file system 1104 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

Report Generation and Feedback

While the system described herein provides circuit simulation and design capabilities for users, the system also provides report generation and marketing feedback information to device manufacturers or suppliers. For example, the server may store in a log file all simulation device types, netlists, modifications to netlists, input files and modifications to input files. Each time a simulation application or input file is downloaded by a registered user, all the above parameters are stored in the log file together with the user's registration identification number or other user identifying data. The log file may be time-stamped and assigned a unique identification number. The server may then process log files periodically (daily, weekly, monthly, etc.) to summarize simulation activity by total web site activity, individual user activity, device activity, etc. This allows the system to track user activity with extreme detail. Examples of a log file and summary report may be found in the above-referenced provisional application. Please see U.S. patent application Ser. No. 09/811,371 for examples of the types of reports which may be generated.

Those skilled in the relevant art will recognize that the system described herein provides numerous benefits. For example, the system provides interactive simulation of manufacturer's components. These simulations can be run in the user's local computing environment. Users can easily experiment with components to evaluate their performance. With access to a full schematic capture capability, the user has enormous freedom in how they can test and evaluate the performance of a manufacturer's component. In a matter of minutes, a user can determine if a part is suitable for a design, where without this capability, it typically would take a user several weeks of time spent on parts investigation and building hardware test setups. Faster design decisions enable the user to reach the marketplace sooner and allow the manufacturer to sell parts more quickly. By offering instant device evaluation, the system can significantly decrease manufacturers' sales costs while improving customer satisfaction. Users or customers can easily evaluate a component by themselves, thus requiring less assistance from applications engineers, particularly for more simple component investigations occurring early in a design process. Manufacturers can focus valuable application and sales resources where they make the most difference with users. Furthermore, manufacturers may offer current information to users quickly and in a format more effective than printed materials or other non-interactive media.

Because manufacturers typically fund the creation and distribution of the manufacturers' versions of the simulation applications and the creation of the input files, individual users need not purchase and employ expensive tools to use the simulation features described herein. A user with a web browser and access to the Internet can employ aspects of the invention and thus quickly begin interactively investigating device performance. Aspects of the invention are simple to use and thus do not require training classes, manuals or experience with complex design tools.

Schematics and reference applications circuits may be designed to show-off differentiating features between a manufacturer's device and those offered by other manufacturers.

Interaction with the Design Center

As described above with respect to FIG. 2, the system may customize content of the input file around a particular user's design requirements. However, aspects of the system also allow for the customization of certain portions of the input file after its creation. Once the user has downloaded an input file from a manufacturer's design center, the schematic capture feature 246 of the manufacturer's version of the simulation application allows the user tremendous freedom in altering the system of interconnected components. In addition to changing the component values, the user may change the interconnectivity of the components. Also, depending on the particular feature limitations of the simulation application, users may be able to add or delete components.

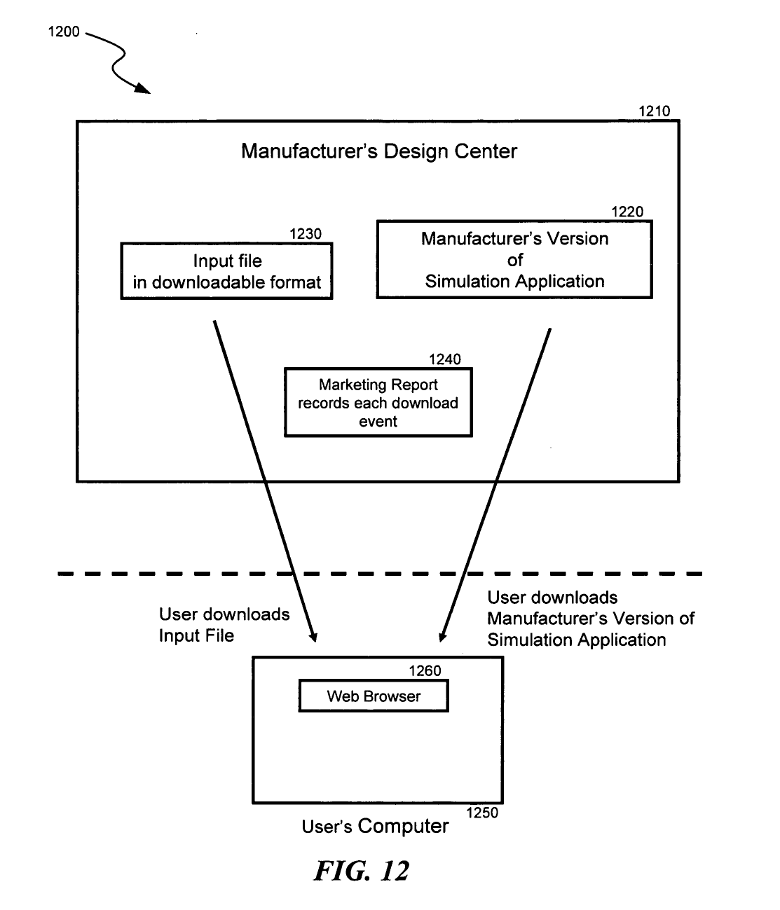

Referring to FIG. 12, a block diagram 1200 illustrating an example of interaction between a user's local computing environment 1250 and a manufacturer's design center 1210 is shown. Similar to FIGS. 1 and 2, the system provides one or more manufacturer's versions of the simulation application 1220 to be downloaded by a user and provides one or more input files 1230 to be downloaded by the user via a web browser 1260 on the user's computing environment 1250. Component 1230 may also gather information from the user (such as the user's design requirements) calculate unknown component values related to those requirements, and provide new and additional input files of the newly modified system for the user to then download.

The enhanced ability to interact with users may reduce sales cycles of the manufacturer's products by reducing the time required to design solutions to user problems and to demonstrate these solutions to the user via the system.

The design center 1210 may also contain a component 1240 that records the user's download events. This component may gather information about the user (such as via a user registration process) and may generate a sales lead each time a user downloads an input file. These sales leads may then be included in a design center marketing report. Further aspects of the report generation and feedback may be found in co-pending and commonly assigned U.S. patent application Ser. No. 10/271,350, filed Oct. 15, 2002.

Examples of other enhanced services that can be offered by this system include a circuit sensitivity analysis, a worst-case analysis, as well as other circuit and device analysis tools that users may wish to employ to obtain further information regarding the user's design and manufacturer's product performance. Such enhanced simulation services may include product creation services to help users more quickly design better products. The service provider may receive fees for such enhanced services. Such fees may be periodic or based on a per-use fee. Rather than receiving fees for only enhanced services, manufacturers and/or end users may provide fees for using basic services under the system. Furthermore, some or all aspects of the system may be sold or licensed as manufacturer or end-user software. Of course, various other revenue models are possible, as those skilled in the relevant art will recognize.

Conclusion

Various communication channels may be used, such as a local area network, wide area network, or a point-to-point dial-up connection instead of the Internet. The server system may comprise any combination of hardware or software that can support these concepts. In particular, a web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.).

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other simulation systems, not only for the electrical circuit simulation system described above. For example, the system may be employed to simulate any system comprising two or more interconnected components, where an end user at a client computer wishes to generate simulation data representing one or more characteristics of information that would be present in the system during its operation. Examples of other systems may include a mechanical system, an electromechanical system, a thermal system, a magnetic system, an electromagnetic system, a fluid dynamical system, a communications network of interconnected communications devices (e.g., telecommunications devices), a traffic network of interconnected roads, a power grid of interconnected power distribution links, a computer system of interrelated software modules, a database of interrelated records, or any node-link structure where nodes represent components, and links represent interconnectivity between the components. The elements and acts of the various embodiments described above can be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all simulation systems that operate under the claims. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A circuit simulation system, comprising:
a simulation subsystem that presents a visual depiction of a circuit schematic and provides a certain functionality based on information contained in an input file, the input file comprising:
a representation of the circuit, wherein the representation is of two or more interconnected components;
simulation instructions that instruct the simulation subsystem to simulate the representation of the circuit schematic;
analysis instructions that instruct the simulation subsystem to analyze results of the simulation of the circuit schematic; and
encrypted modifying instructions that define the functionality provided by the simulation subsystem;
wherein the simulation subsystem provides an enhanced functionality defined by the modifying instructions when the simulation subsystem is capable of decrypting the encrypted modifying instructions; and
wherein the simulation subsystem provides a default functionality when the simulation subsystem is not capable of decrypting the encrypted modifying instructions.

2. The circuit simulation system of claim 1, wherein the default functionality comprises a default set of features and a default set of feature limitations; and wherein the enhanced functionality comprises features not included in the default set of features and a relaxed set of feature limitations.

3. A method of simulating interconnected components representing a system, comprising:
presenting input data to a simulation application, the input data comprising data representing a system of interconnected components and data representing functionality of the simulation application, wherein the simulation application is configured to permit two levels of functionality, wherein the two levels of functionality comprises a first level of functionality and a second level of functionality that permits additional functions not provided by the first level of functionality;
determining the level of permitted functionality of the simulation application based at least in part on the input data; and
performing a simulation of the interconnected components representing a system based on the determined level of permitted functionality, wherein the performance of the simulation uses the data representing the system of interconnected components.

4. The method of claim 3, the input data further comprising:
data representing simulation instructions; and
data representing simulation analysis instructions;
wherein the performance further uses the data representing simulation instructions and the data representing simulation analysis instructions.

5. The method of claim 3, further comprising:
presenting a visual depiction of the simulation to a user; wherein the visual depiction includes a visual display of the interconnected components and a display showing characteristics of an information signal that would be present during simulation of the interconnected components.

6. The method of claim 3, further comprising:
presenting to a user a display of information related to a provider of the simulation application or a provider of the input data.

7. The method of claim 3, wherein the data representing the permitted functionality of the simulation application is encrypted and the simulation application determines the level of permitted functionality after decrypting the encrypted data.

8. The method of claim 3, wherein the input data further comprises data related to calculated values of the interconnected components, wherein the calculated values are customized based on design requirements of a particular user.

9. A simulation system, comprising:
a simulation component that presents a description of a system of interconnected components and provides a certain permitted functionality based on information obtained from input data, the input data comprising:
a representation of the system of interconnected components, wherein the representation is of two or more interconnected components; and
encrypted modifying instructions that permit at least some of the permitted functionality provided by the simulation component.

10. The simulation system of claim 9, the input data further comprising:
simulation instructions that instruct the simulation component to simulate the representation of the system of interconnected components; and
analysis instructions that instruct the simulation component to analyze the simulation of the system of interconnected components.

11. The simulation system of claim 9, wherein
the simulation component provides an enhanced functionality when permitted by the modifying instructions when the simulation component is capable of decrypting the encrypted modifying instructions; and
the simulation component provides a default functionality when the simulation component is not capable of decrypting the encrypted modifying instructions.

12. The simulation system of claim 9, wherein the permitted functionality is one of a default functionality that comprises a default set of features and a default set of feature limitations or an enhanced functionality that comprises features not included in the default set of features and a relaxed set of feature limitations.

13. The simulation system of claim 9, wherein the simulation component is associated with a first manufacturer and the input data is associated with a manufacturer other than the first manufacturer.

14. The simulation system of claim 9, wherein the input data comprises at least two different sets of encrypted modifying instructions each encrypted with a separate encryption key, and wherein further the simulation component is not capable of decrypting every set of encrypted modifying instructions.

15. The simulation system of claim 9, wherein some of the functionality of the simulation component is not defined by the encrypted modifying instructions that define the permitted functionality provided by the simulation application.

16. The simulation system of claim 9, the input data further comprising:
encrypted simulation content that describes at least a portion of one or more simulation models related to the interconnected components.

17. The simulation system of claim 16, wherein the simulation component further comprises an enhanced functionality that is not defined by the encrypted modifying instructions and wherein the input data further comprises a first encryption key encrypted by a second encryption key, the first encryption key capable of unlocking the encrypted simulation content, and wherein further the simulation component is configured to unlock content encrypted with the second encryption key and access the first encryption key, in order to unlock the encrypted simulation content with the first encryption key.

18. The simulation system of claim 16, wherein the input data and a first encryption key are created after the simulation component is created and received by a user, the input data further comprising:
a first encryption key encrypted by a second encryption key, the first encryption key capable of decrypting the encrypted simulation content;
wherein the simulation component is configured to use the second encryption key in order to decrypt the first encryption key in order to decrypt the encrypted simulation content in order to perform one or more simulations of the system of interconnected components using input data and a first encryption key created after a creation date of the simulation application.

19. One or more computer memories collectively containing a data structure representing an input for use with a simulation application, the data structure comprising a representation of two or more interconnected components and encrypted data containing modifying instructions unique to a certain manufacturer and associated with functionality of the simulation application, wherein the modifying instructions cause the simulation application to provide a predetermined functionality only when the simulation application is able to access the modifying instructions.

20. The computer memory of claim 19, wherein the data structure further comprises data related to simulation instructions or simulation analysis instructions.

21. The computer memory of claim 19, wherein functionality refers to a set of features, a set of feature limitations, or both.

22. The computer memory of claim 19, wherein the representation of two or more interconnected components represents a circuit schematic.

23. A method of providing simulation services to a user, the method comprising:
presenting a simulation application to a user;
receiving an indication from the user that the user wishes to obtain the simulation application;
transmitting the simulation application to the user;
presenting input data to the user, the input data comprising a model of a system to be simulated and encrypted modifying instructions that determine a certain functionality of the simulation application;
receiving an indication from the user that the user wishes to obtain the input data; and
transmitting the input data to the user;
wherein the user is able to simulate the model of the system in the user's local computing environment.

24. The method of claim 23, wherein receiving an indication from the user that the user wishes to obtain the input data further comprises:
receiving user design requirements from the user; and
modifying component values of the model of the system based on the user design requirements,
wherein the input data to be transmitted to the user comprises the modified component values.

25. The method of claim 23, wherein marketing reports are generated after transmitting the simulation application or after transmitting the input data.
